(19) United States
(12) Patent Application Publication
(10) Pub. No.: US 2006/0162672 A1
(43) Pub. Date: Jul. 27, 2006

(54) Casting and retrieving device for training dogs

(76) Inventor: Thomas Dokken, Northfield, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/390,891

(22) Filed: Mar. 28, 2006

Related U.S. Application Data
(63) Continuation of application No. 10/845,880, filed on May 14, 2004, now abandoned.
(60) Provisional application No. 60/470,375, filed on May 14, 2003.

(51) Int. Cl. A01K 29/00

(52) U.S. Cl. 119/707

(57) ABSTRACT

A retrieving device for use in training dogs, the device being adapted to be cast, retrieved, and released from a casting line. The devices includes a body portion adapted to be grasped by a dog, a casting mechanism adapted to permit the body portion to be releasably connected to a casting line, and/or one or more components adapted to impart a desired path as the body portion is pulled through water. Such paths can include, for instance, to skim along the top of the water, or to dive or bob periodically.

### CROSS REFERENCE TO RELATED APPLICATIONS

This application is a continuation of U.S. application Ser. No. 10/845,880, filed May 14, 2004, which claims priority to U.S. Provisional Application Ser. No. 60/470,375, filed May 14, 2003, the disclosures of which are herein incorporated by reference.

### TECHNICAL FIELD

The present invention relates to animal training devices, and in particular to devices such as retrieving dummies for use in training dogs to retrieve downed waterfowl on land and water.

### BACKGROUND OF THE INVENTION

Dogs have long been trained and used for retrieving downed waterfowl. For perhaps an equally long time it has been the practice to train dogs for such purposes by having the dogs repeatedly retrieve thrown objects such as sticks. The dog must learn a number of skills, including when and how to approach the waterfowl and return it to the trainer or hunter. They should also, however, learn how to best to grasp the waterfowl in order to minimize further damage to the skin or tissues of the downed bird. Simple retrieving dummies, such as sticks, are of little use in this respect.

Present day techniques for training retrieving dogs generally involve the use of home-made or commercially supplied retrieving dummies. As with sticks, such dummies are of little help in training the dog how best to grasp the downed bird.

U.S. Pat. No. 745,806 (Erb) and U.S. Pat. No. 5,038,717 (Bent), for instance, describe devices for use in training dogs. Erb describes a retrieving device having a mouthpiece and legs supporting the mouthpiece above the ground. Bent, in contrast, describes an adjustable halter that fits about the dog's head, which can be attached to a training dummy and used to keep the dog's head down.

Examples of commercially available devices include those identified at page 14 of Scott's Dog Supply 1991/1992 catalog. Certain devices (Items 3592 TDY and 3593 TDY) are pictured and described as “easy throwing”. They are also described as being made of a “closed cell foam” with a durable nylon cover, and as having a floating rope that pulls out from either end. The orange rope is said to help the trainer find the dummy in grass or snow. Also in this catalog, and on the same page, is shown a “plastic knobby dummy” (Item 3595 KDY) made of heavy duty vinyl and provided in either white or orange. Each device, however, is generally rod-like in shape, and bears little resemblance to a real bird.

Another device presently on the market is the “Ded-Duk Dog Trainer” shown in the “PlastiDuk” product brochure of Plasti-Products, Klamath Falls, Oreg. This device is described as “soft and pliable, yet tough and durable, made from non-toxic vinyl plastic. The exact likeness of a dead drake greenhead mallard floating on the pond”.

A number of drawbacks are associated with commercially available dummies, including the fact that most of them tend to wear out quickly in the course of repeated use. Also, they tend to provide an appearance and/or texture that is not life-like. Also, commercially available devices do not appear to be designed or intended to be useful for training the dogs to grasp the dummy in a particular manner or location on the dummy.

Although the devices presently available have some utility, as with any training exercise or device, it is clear that the techniques and skills associated with training dogs could be significantly improved with the availability of improved training devices.

Applicant has itself developed and commercialized a training device corresponding to the description in issued U.S. Pat. No. 5,706,762. While such devices have met with considerable commercial success, available under the tradename Dokken Dead Fowl Trainers, there remain situations in which further qualities have been found to be desired, particularly with regard to better approximating the different movements of downed fowl.

### BRIEF DESCRIPTION OF THE DRAWING

In the Drawing:

FIG. 1 is a side perspective view of an assembled and ready-to-use device in accordance with a preferred embodiment of the present invention;

FIG. 2 is a top perspective view of the device in FIG. 1, shown without the tail portion;

FIG. 3 shows a longitudinal cross-sectional view of the device shown in FIG. 1.

FIG. 4 is a perspective view of the device of FIG. 1 being grasped within the mouth of a retrieving dog.

FIGS. 5-12 show various views of a preferred embodiment of the present invention, including for both a skimming dummy and a diving dummy.

### SUMMARY OF THE INVENTION

In a preferred embodiment, the present invention provides a retrieving device for use in training dogs, the device including a body portion adapted to be grasped by a dog, a casting mechanism adapted to permit the body portion to be releasably connected to a casting line, and/or one or more components adapted to impart a desired path as the body portion is pulled through water. Such paths can include, for instance, to skim along the top of the water, or to dive or bob periodically.

The body portion can be provided in any suitable form and of any suitable material, including conventional rod-like devices as well as those intended to reproduce the look and feel of downed fowl. Commercial devices include, for instance, plastic and rubber dummies such as those available from Lucky Dog, Neuman & Bennett, Hallmark, Scott, and DT Systems and Sport'n Dog. Such devices can be retrofitted to provide a casting/retrieving device of the present invention, as by the use of a kit containing various components, though preferably the devices are manufactured to provide such features as sold.

The casting mechanism associated with the device can be provided in any suitable form to permit the device to be cast with a line, such as a sufficiently strong fishing line, to then be pulled along the water, and preferably, to permit the device body to be released from the line in a desired manner, as by a sharp tug on the casting line itself. The casting mechanism, in turn, can include one or more components that are together adapted to permit the device to be cast, retrieved, and/or released from the casting line. These functions are considered novel in combination with a retrieving dummy, and can be accomplished in any suitable manner and with any suitable retrieving device, including those exemplified and specifically described herein.

In order to cast the device, a preferred casting mechanism includes a portion that is sufficiently strong and associated with the device (e.g., adhered thereto or embedded in it), to permit the casting line to remain attached to the device when cast (or thrown or launched). As shown in various Figures below, such a portion can be provided in the form of a hook embedded in the device body itself, oriented so as to provide its open face in a downward position when the device body is floating in the water.

In order to retrieve the device, the casting mechanism will generally also include a portion adapted to be releasably attached to the device body, so as to permit the device body to be pulled through the water, and later disconnected from the casting line by the trainer. As shown and described below, such a releasable attachment portion can include a metal ring, adapted to be positioned over the embedded hook in order to cast the device, and to fall off the hook once the device body floats in the water. The metal ring is attached to both the casting line itself, and at a substantially opposite point, to a terminal release rope portion. The release rope portion itself terminates distally with one or more enlarged terminal regions, as in the form of an attached knot or bead. The releasable terminal regions are themselves adapted to be positioned upon the device body, e.g., under an elastic band integral with or attached thereto (e.g., circumferentially around the device body), in order to attach the body to the casting line, via the release rope and ring portions, during the retrieving process.

In order to release the device, the terminal portions of the release rope are pulled from their retained position within the elastic band, in order to permit the casting line, with metal ring and release rope portions still attached, to be retrieved by the trainer and the device body to be retrieved by the dog. The connection between the casting line and the device body can be of any suitable type and configuration to permit the connection to be maintained under the conditions of retrieving the device, and to become disconnected upon the application of suitable force or other actions of the trainer, or the dog itself.

Both the orientation of the device body and its path through the water can be controlled using any suitable means. In one embodiment, the device body can be provided with one or more edges or lips integral therewith or extending therefrom, in the manner of a fishing lure, the orientation, angle and dimensions of which will determine the path of the body as it is pulled through the water.

In another embodiment, as shown herein, the device body is itself angled at its leading end, so as to cause the device to either skim the water surface or to catch, and thereby periodically dive into, the water surface. The same device body shape can be used in either the skimming or diving mode, by appropriately positioning a weight that will cause the device body to float in a desired orientation. The weight can be temporarily or permanently attached to or embedded within the device body. If temporarily attachable to the body, the same device body can be used in either the skimming or diving mode with minor modifications (attaching the weight as desired, and turning the embedded hook as appropriate). With the weight permanently attached to or within the body, the trainer will typically employ different devices for skimming and diving, respectively.

With the weight attached to or implanted within the shorter longitudinal surface of the body, the longer surface will be upon the water, and the angle of its leading edge will cause the device body to catch the water and dive. With the weight attached to or implanted within the longer longitudinal surface of the body, the shorter surface will be upon the water, and the device body will tend to skim across the water without catching the surface. In either embodiment, the embedded hook is oriented such that its open face is downward when the body is floating, to permit the casting ring to fall off.

In use, the metal ring is positioned over the embedded hook, and the assembled device is cast over the water with a pole. Upon hitting the water, the body portion will orient itself in a lifelike fashion, and depending on its shape and the position of its weights, whereupon the metal ring will fall off the hook, leaving only the terminal portion(s) of the release rope connecting the body of the device to the casting line, via the metal ring.

By retrieving the casting line, the device can be pulled through the water, taking a path defined by other features as described herein, until the user desires to disassociate the device from the line, generally as the dog approaches or grabs the device body. At that time, the trainer will apply a sharp tug on the line, with a force sufficient to pull the rope tabs from their retained position within the line elastic band, thereby disconnecting the device.

The present invention therefore provides a casting and retrieving device for training dogs, as well as a method of making such a device, a method of using such a device, and kits and components for use in assembling and repairing such a device.

### DETAILED DESCRIPTION

By way of example, the invention will be further described with reference to Applicant's prior disclosure, although it is understood that the present invention should be in no way limited to any particular embodiment or retrieving device.

In such a preferred embodiment, the present invention provides a device for training dogs, the device being provided in the form of a retrieving dummy having a life-like appearance and texture. In addition to being anatomically accurate, the device of the present invention is durable in the course of repeated, rigorous, and demanding use. Moreover, the device is configured to encourage and train the dog to grasp the device in the proper manner, i.e., by the body portion and away from the head, feet or tail of the bird.

The body portion is preferably constructed of any suitable material that is resistant to the repeated stresses, punctures, and other penetrations caused by dog's teeth. After an dog releases its grip on the dummy, the holes where the teeth had penetrated tend to close themselves (i.e., heal) within a short period of time, generally within about an hour or so, leaving at most a slightly noticeable scar but not appreciably weakening the dummy. It is this healing effect that gives the material its self-healing designation. Surprisingly, however, the dummy is also surprisingly strong and rigid, and durable in repeated use.

In a preferred embodiment a device of the present invention comprises a retrieving dummy comprising:

(a) a unitary body portion formed of a durable, self-healing material and having a head region and an opposite tail region, the body portion having a conduit traversing a generally central longitudinal axis, the length and circumference of the body portion being dimensioned to be releasably grasped within the mouth of a retrieving dog,

(b) a rigid head portion attached to the body portion and configured to provide the appearance of a drooped waterfowl head, and optionally,

(c) feet or tail portions attached to the body portion and configured to deter the dog from grasping the device at or near the tail region of the body portion.

The dummy is preferably provided in the form of a three-dimensional, durable, life-like, waterproof, buoyant, and reusable device. In a preferred embodiment the device further comprises a rope traversing the central conduit, the rope being of sufficient length to exit the conduit at the head region and serve as head attachment means, and to exit the conduit at the tail region and serve as handle means of sufficient dimension to be grasped by a trainer in order to toss the device.

In the case of a throwing dummy, the rope can be grasped at the tail region and used by the trainer to throw the device. In the case of a “bumper” dummy, i.e., a dummy to be ejected or thrown from a gun or hand-held throwing device, the handle means can be omitted.

The device, and in particular the body, head and leg portions are each configured in a manner that deters the dog from biting the tail or head regions, and in turn, that encourages and trains the dog to grasp the downed waterfowl correctly, i.e., by its torso.

In yet a further preferred embodiment the body portion is formed of a durable, moldable foamed polyurethane material having an integral skin system that withstands the rigors of repeated use, yet can be used to provide the device with a realistic and lifelike texture and dimensions.

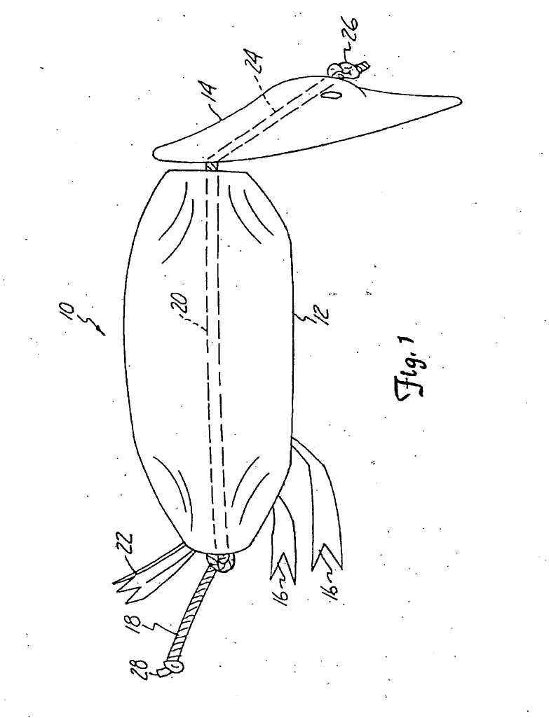

In a preferred embodiment, the present invention provides a three-dimensional, durable, life-like, waterproof, buoyant and reusable retrieving dummy. Such a preferred device of the present invention will be further described with reference to the Drawing, wherein FIGS. 1-4 show various views of a conventional assembled and ready-to-use device in the form of a throwing dummy, in a form that can be adapted to be cast, retrieved and release in the manner described herein.

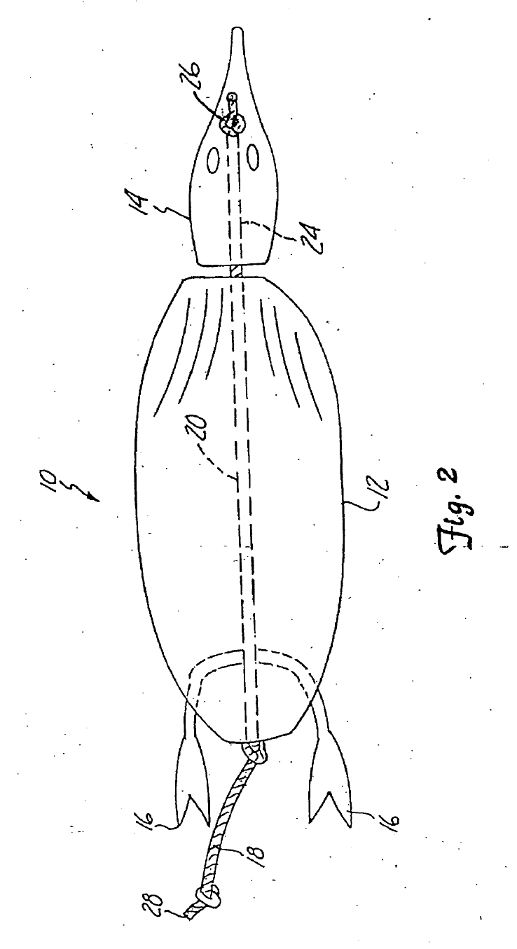

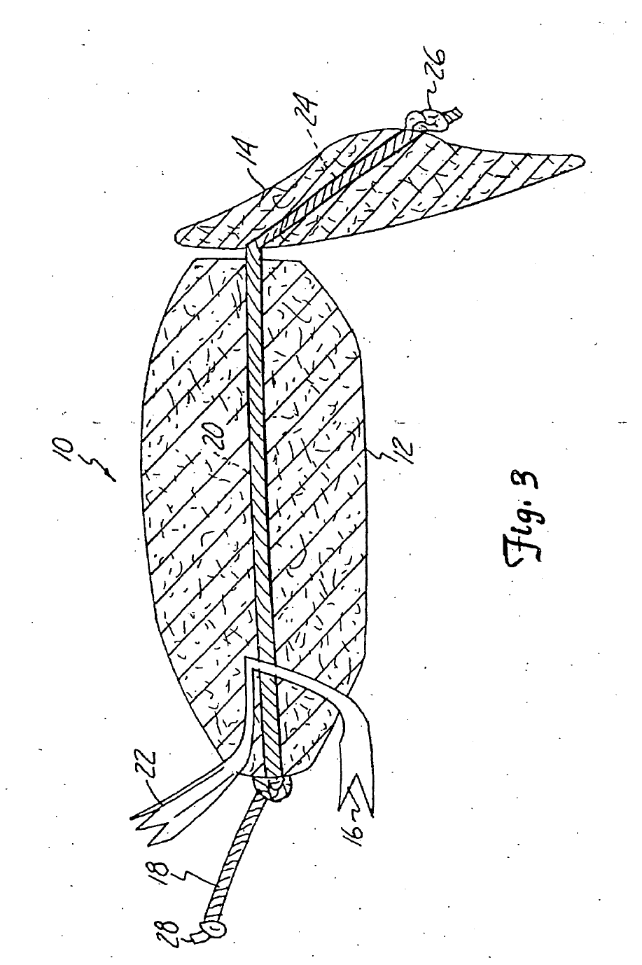

In FIG. 1, device 10 is shown comprising a body portion 12, a head 14, a pair of legs 16, and central rope 18 traversing conduit 20. FIG. 2 is a top perspective view of the device in FIG. 1, and FIG. 3 shows a longitudinal cross-sectional view of the device of FIG. 1 in order to show details associated with the central conduit and attachment of component parts.

It can be seen that the body portion is provided with a central conduit 20 traversing the longitudinal central axis of the generally oval body portion. Rope portion 18 is positioned through the central conduit in order to provide a number of functions, including a means for head attachment, and a means for grasping and/or throwing the device. Optionally included in the device, and shown in FIG. 1, is a life-like tail portion 22.

The body portion 12 of the device is preferably unitary, i.e., either formed of or formed into a material that remains substantially intact in the course of repeated use. Such material is also durable in that it is able to withstand the rigors of being repeatedly thrown and retrieved. A device of the present invention can typically be used repeatedly, for field training sessions that involve several dogs and/or several dozen, if not scores of retrievals, without exhibiting wear or tear that would render it no longer useful. After it begins to show wear, the device can optionally be disassembled in order to replace the worn body portion and be reintroduced into use.

Materials used to form the body portion are also preferably “self-healing”, in that they can be repeatedly penetrated by the teeth of several dogs, and upon release can substantially close the sites of penetration, or otherwise remain structurally intact. Examples of preferred materials include, but are not limited to foamed plastics, and in particular, flexible foamed cellular polymers. Suitable foams have been used in constructing such things as dart boards and archery targets and are described, for instance in U.S. Pat. No. 4,066,261 (Stewart); U.S. Pat. Nos. 4,239,236; 4,244,583; and 5,368,307 (Hotchkiss).

In addition to being durable and self-healing, suitable materials for forming the body portion also provide an optimal combination of such physico-chemical properties as density, cell structure, cell size and geometry, the fraction of open cells and gas composition. In use, the materials preferably also provide an optimal combination of such properties as weight, moldability, waterproof, rigidity and flexibility, cost, nontoxicity, tear and impact resistance, water proof, buoyancy, and the ability to be painted.

Examples of suitable materials include, for instance, foamed plastic materials such as foamed polyethylenes, polystyrenes, and polyurethanes. Such materials are commercially available from a number of sources and include, for instance, an expanded polyethylene manufactured under the “Ethafoam” brand by the Dow Chemical Company. This is a tough, flexible and resilient closed cell foam material which can be cut, shaped or molded into the desired configuration.

Another such material is the “Styrofoam” brand of expanded polystyrene manufactured by Dow Chemical Company. This material is an extruded multi-cellular polystyrene foam obtainable in solid semi-rigid billets, boards and other commercial shapes.

Preferred materials for use in constructing the body portion are typically cellular foams, and preferably self-healing, semi-rigid or flexible cellular foams. Suitable foams can be prepared from a variety of materials, and preferably include the use of “cast (polyurethane) elastomers” to form polyurethane foams as described, for instance, in “Polyurethanes”, pages 890-897 in Concise Encyclopedia of Polymer Science and Engineering, J. Kroschwitz, ed., John Wiley & Sons, 1990, the disclosure of which is incorporated herein by reference.

In a preferred embodiment, the body material is formed using a flexible, cellular polyurethane foam system such those available under the “IS” (for “integral skin”) series of Isofoam brand foams from IPI (a Division of PMC, Inc., Sun Valley, Calif.). By “integral skin” it is meant that the foam is “self skinning”, that is, it forms its own skin as it expands and contacts a mold. Such foams are commonly described as useful in the automotive, leisure, and furniture industries, for instance for making headrests and arm rests.

An example of a preferred material for use in making the body portion is the polyurethane system identified as IPI Product IS-1324. This product is described as a water blown integral skin formulation, used to produce a foam having a tough skin from about 15 pounds/square foot. Such foams preferably provide a molded density of at least about 20 pcf and a core density of at least about 15 pcf (pounds/cubic foot). They further provide a tensile strength of at least about 170 psi for the formed skin and about 90 psi (pounds/square inch) for the core; and elongation strength of at least about 150% for the skin and for the core; and a tear strength of at least about 20 pli (pounds/linear inch) for the skin and 15 pli for the core.

Although such foams are not generally considered to provide the same extent of self-healing as foams used to prepare targets and the like, these self-skinning foams surprisingly provide an optimal combination of properties for use in the present invention.

The head portion 14 of a device of the present invention is preferably constructed of a durable material, and positioned on the body portion to provide the drooped appearance of a downed waterfowl. The head portion is attached to the body portion, for instance by passing rope 18 through a conduit 24 in the head, in order to tie it off in a terminal knot 26. The head is preferably configured to provide the appearance of a drooped waterfowl head, and attached to the body portion in a manner that allows the head to rotate freely in an axis about the central axis of the body, but that nevertheless retains the head in fairly tightly and close proximity to the body portion.

The head portion 14 of the present invention is preferably formed of a rigid polymeric material. Use of a rigid material better ensures that the dog will not grasp the dummy by its head region. Rigid polyurethanes and other such materials are particularly useful and within the skill of those in the art. A preferred rigid polyurethane for forming the head is available as Catalog No. 2016-38, Premium Polymers, Austin, Tex.

The feet and tail portions are configured, again, to provide a life-like appearance and deter the dog from grasping the in the tail region. The feet and tail portions can be attached within recesses formed within the body portion and configured to deter the dog from grasping the device at or near the tail region of the body portion. An example of a preferred material for making the feet and legs is the product identified as “E-1048”, available from IPI. The material can be colored at the time of preparation and use, e.g., in order to provide feet that have a realistic orange color.

In a preferred embodiment the device further comprises a rope traversing the central conduit and having sufficient length to exit the conduit at the head region and serve as head attachment means, and to exit the conduit at the tail region and serve as handle means capable of being grasped by a trainer in order to toss the device. Suitable ropes can be provided of strong and durable natural or synthetic materials, e.g., polymeric materials such as nylon. The rope can be provided in any suitable color, e.g., natural colors, blaze orange or another color that allows it to either be hidden or seen more readily in the field.

Devices of the present invention can be made using techniques and tools well within the skill of those in the art, given the present description. In a preferred embodiment, a reusable, permanent body portion mold is first formed, e.g., by carving a suitable material. The mold is designed for repeated use, and used to retain and form the blend of materials used to form the foamed cellular material. The mold is used to form a body portion in a generally oval, life-like shape and dimensions. Suitable body portion typically has an overall length of approximately 8 to 10 inches, and a diameter at its widest point of approximately 3 to 5 inches. The body portion can be tapered as it approaches each end, with optionally truncated ends.

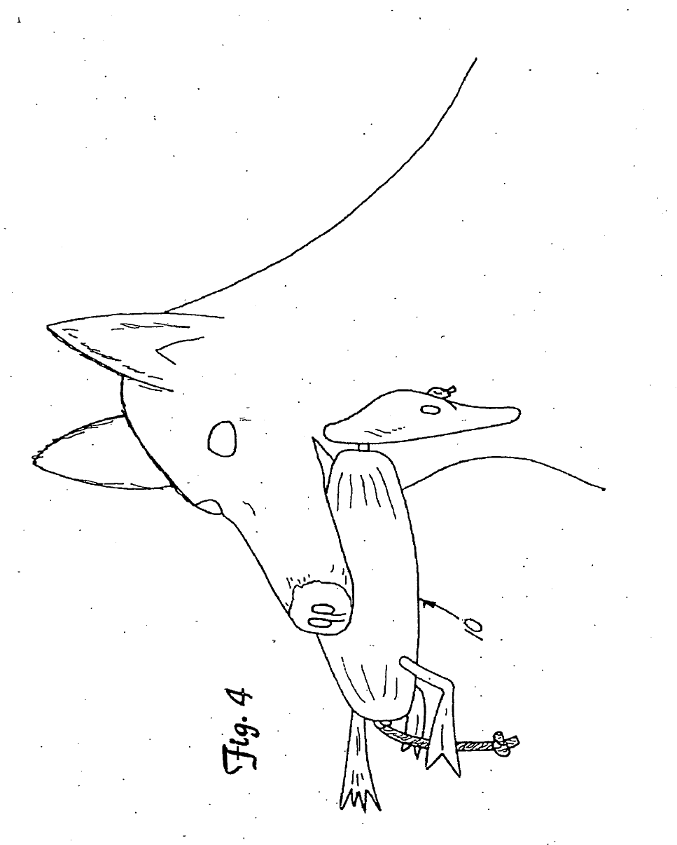

Once the mold has been created, and in the course of producing devices, the feet portions 16 and tail portion 22 are preferably first produced. The feet and tail can be placed in the mold and the body portion cast around them to secure them in position. Optionally, and as shown in FIG. 4, they can be constructed in such a manner that they are attached to one another, in order to improve the ability to anchor them in the body.

Also, the head portion 14 is separately formed, preferably including the rope either cast or glued within it at the time. Either a central conduit is formed in the cast body portion, or preferably the body is itself cast in a manner that provides a central conduit as it forms around the rope. A rope of suitable length and dimensions, and previously cast or glued into the head, can then be passed through the body portion conduit and tied off at the tail end to form knot 28. In an alternative embodiment, in which the device will be used as a bumper dummy, rather than throwing dummy, there will be no handle and little if any rope exposed at the tail end.

Using the preferred construction materials, the device will typically be made in a two-step process of first constructing the individual components, and second, assembling them into the final device. The various components can be colored, e.g., painted, or otherwise decorated, either at the time they are formed or after they have been assembled to form a device of the invention.

Also disclosed is a method of training a dog comprising the steps of (a) providing a training device as described herein, and (b) throwing the device to a distant location to be retrieved by the dog. Those skilled in the art of training retrieving dogs will, given the present description, appreciate the manner in which devices of the present invention can be used. In a preferred embodiment, the device is generally thrown a sufficient distance from the dog to be trained, preferably onto the surface of a body of water. Generally, the device will be tossed or thrown by the trainer, and the dog provided with a signal to begin to retrieve the dummy. The dog will retrieve the dummy, grasping it in the proper location and manner, and return it to the trainer.

FIG. 4 is a perspective view of the device of FIG. 1 being grasped within the mouth of a retrieving dog. It can be seen that the device is dimensioned to be comfortably held in the dog's mouth, in a manner that substantially prevents the dog from holding it in any other, inappropriate manner.

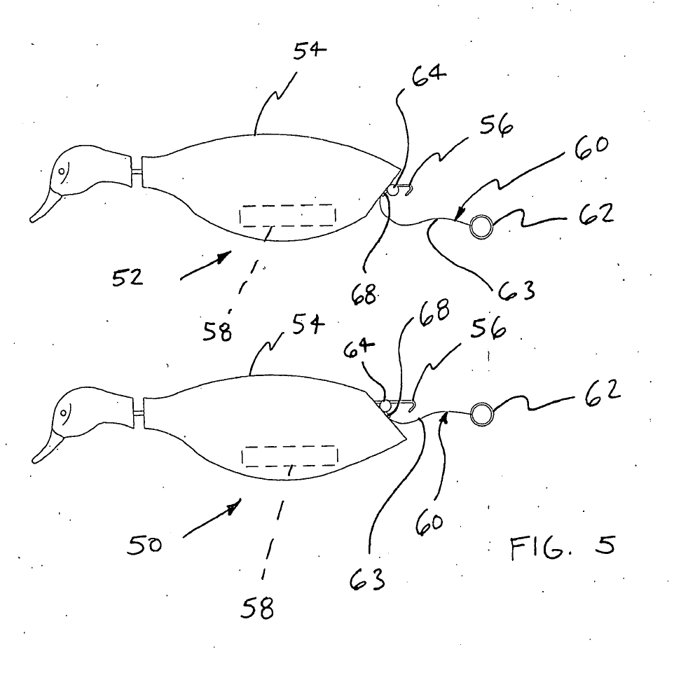

FIG. 5 is a side view showing a diving dummy 50 and a skimming dummy 52. Each dummy includes a body 54 and a hook 56. A weight 58 is disposed inside each dummy. A ring assembly 60 is detachably attached to dummy by an elastic member 68 (e.g., rubber band). Each ring assembly 60 includes a ring 62, a string 63 and a bead 64.

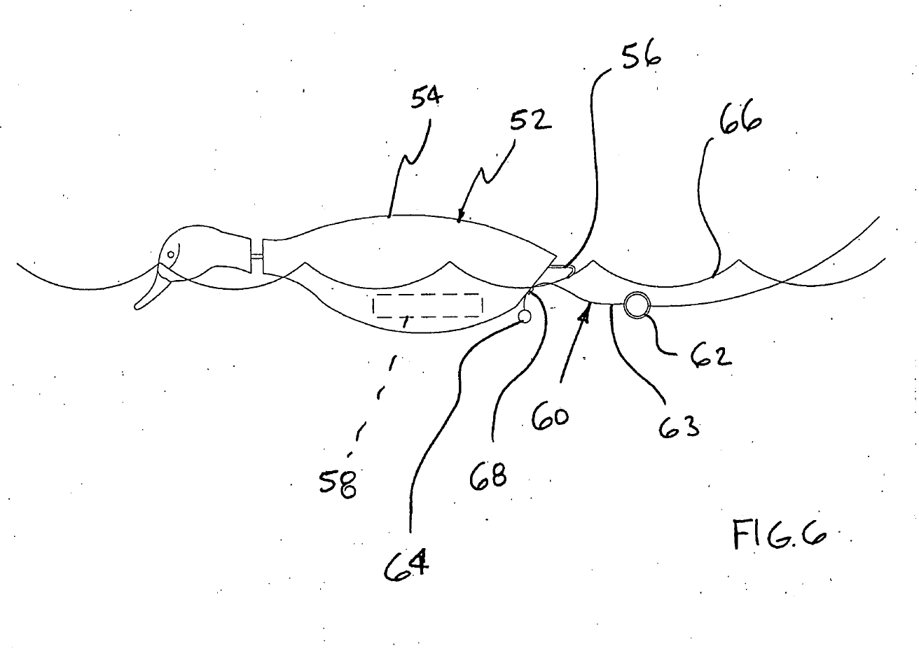

FIG. 6 is a side view showing a skimming dummy 52 floating in water 66. Skimming dummy includes a body 54 and a hook 56. A weight 58 is disposed inside body 54 of skimming dummy 52. A ring assembly 60 is detachably attached to skimming dummy 52 by an elastic member 68. Ring assembly 60 includes a ring 62, a string 63 and a bead 64 (e.g., in the form of a knot).

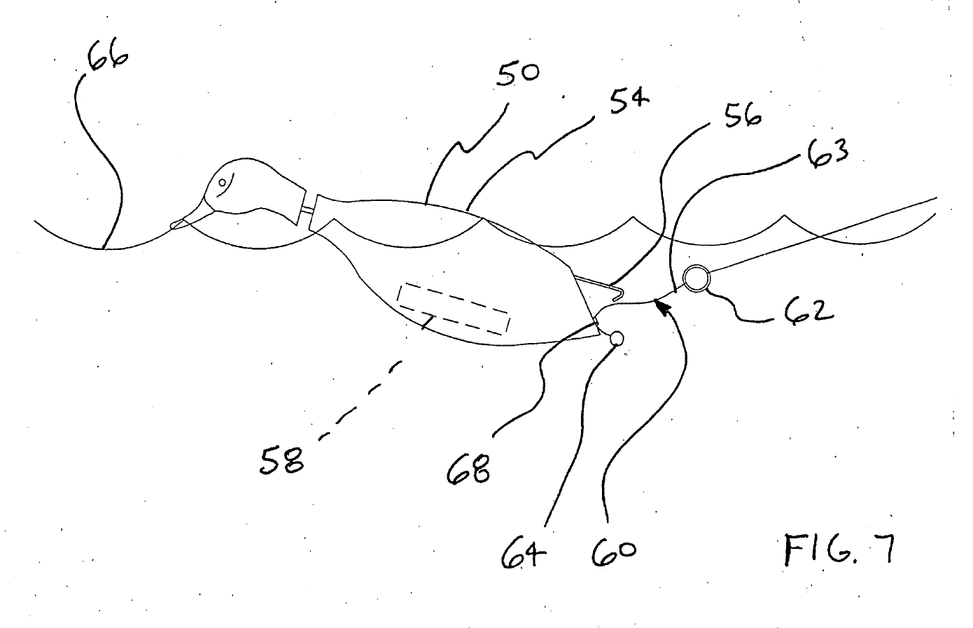

FIG. 7 is a side view showing a diving dummy 50 floating in water 66. Diving dummy includes a body 54 and a hook 56. A weight 58 is disposed inside body 54 of diving dummy 50. A ring assembly 60 is detachably attached to diving dummy 50 by an elastic member 68. Ring assembly 60 includes a ring 62, a string 63 and a bead 64.

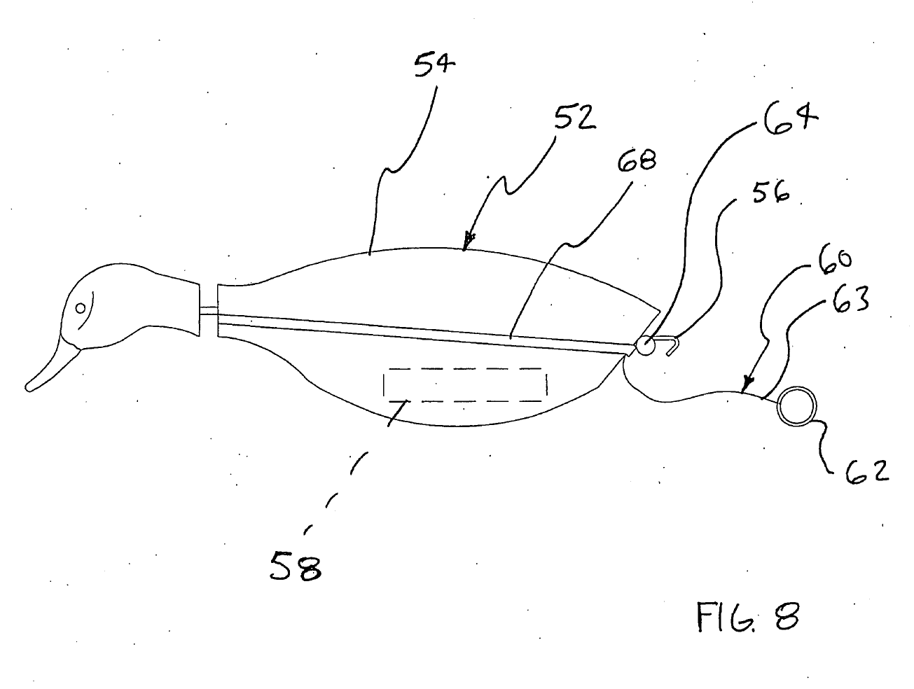

FIG. 8 is a side view showing a skimming dummy 52 having a body 54 and a hook 56. A ring assembly 60 is detachably attached to skimming dummy 52 by an elastic member 68. In the present embodiment, elastic member 68 comprises a rubber band that is circumferentially disposed about body 54. Ring assembly 60 includes a ring 62, a string 63 and a bead 64. A weight 58 is disposed inside body 54 of skimming dummy 52. In this figure, weight 58 is illustrated using dashed lines.

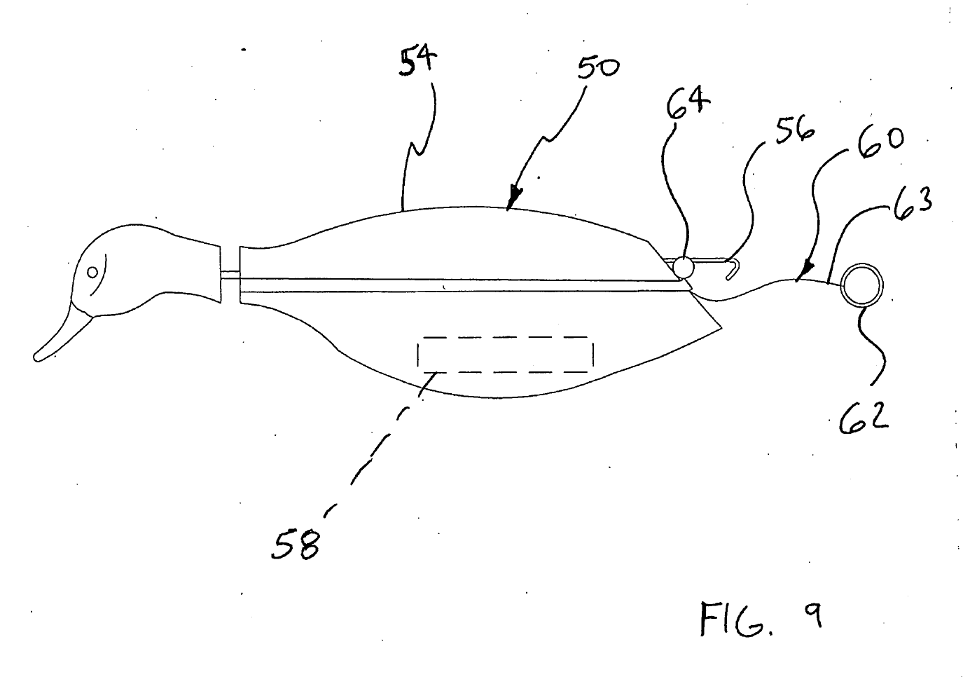

FIG. 9 is a side view showing a diving dummy 50 having a body 54 and a hook 56. A ring assembly 60 is detachably attached to diving dummy 50 by an elastic member 68. In the present embodiment, elastic member 68 comprises a rubber band that is circumferentially disposed about body 54. Ring assembly 60 includes a ring 62, a string 63 and a bead 64.

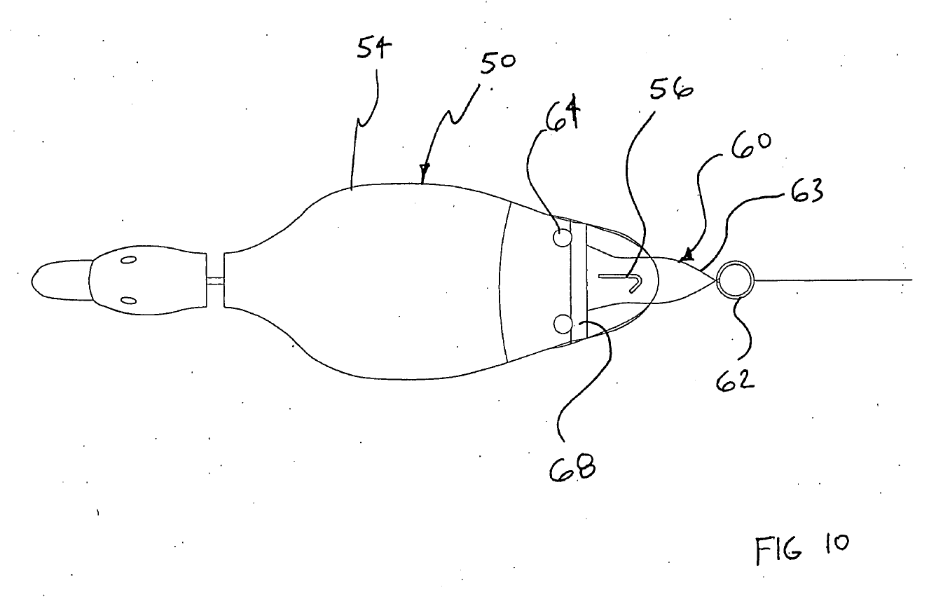

FIG. 10 is a top view of a diving dummy 50 having a body 54 and a hook 56. A ring assembly 60 is detachably attached to diving dummy 50 by an elastic member 68. In the present embodiment, elastic member 68 comprises a rubber band that is circumferentially disposed about body 54. Ring assembly 60 includes a ring 62, a string 63 and a bead 64. A weight 58 is disposed inside body 54 of diving dummy 50. In this figure, weight 58 is illustrated using dashed lines.

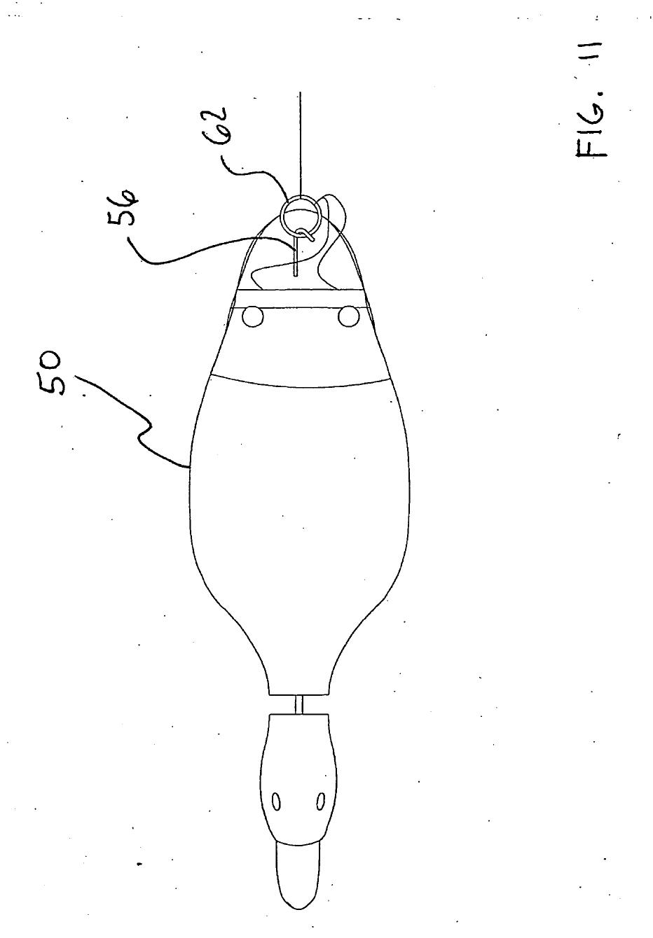

FIG. 11 is an additional top view of diving dummy 50 shown in the previous figure. In the embodiment of FIG. 11, hook 56 is shown engaging ring 62.

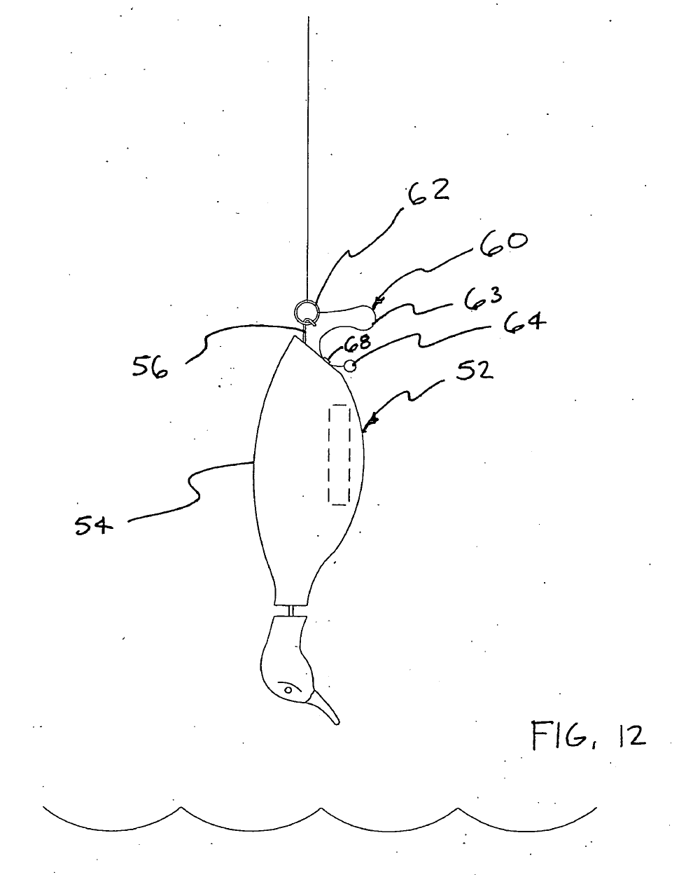

FIG. 12 is a side view showing a skimming dummy 50 having a body 54 and a hook 56. A ring assembly 60 is detachably attached to diving dummy 50 by an elastic member 68. Ring assembly 60 includes a ring 62, a string 63 and a bead 64. In the embodiment of FIG. 12, ring 62 and hook 56 cooperate to support diving dummy 50.

While the preferred embodiment of the invention has been described in detail, it is apparent that various changes and modifications may be made to the overall arrangement without departing from the spirit and scope of the invention. Accordingly, the true scope of the invention is to be determined from the accompanying claims.

What is claimed is:

1. A retrieving device for use in training dogs, the device comprising a body portion adapted to be grasped by a dog, a casting mechanism adapted to permit the body portion to be releasably connected to a casting line, and/or one or more components adapted to impart a desired path as the body portion is pulled through water.

2. A device according to claim 1 wherein the desired path is selected from the group consisting of skimming along the top of the water, diving, or bobbing periodically.

3. A device according to claim 1 wherein the casting mechanism comprises a portion that is attached to the body portion with sufficient strength to permit the casting line to remain attached to the device when cast, thrown, or launched.

4. A device according to claim 3 wherein the casting mechanism portion comprises a hook embedded in the device body itself, oriented so as to provide its open face in a downward position when the device body is floating in the water.

5. A device according to claim 1 further comprising a portion adapted to be releasably attached to the device body, so as to permit the device body to be pulled through the water, and later disconnected from the casting line.

6. A device according to claim 5 wherein the releasable attachment portion comprises a metal ring, adapted to be positioned over a hook embedded in the body portion and to fall off the hook once the device body floats in the water.

7. A device according to claim 6 wherein the metal ring is attached to both the casting line itself, and at a substantially opposite point, to a terminal-release rope portion that itself terminates distally with one or more enlarged terminal regions.

8. A device according to claim 7 wherein the releasable terminal regions are adapted to be positioned upon the device body.

9. A device according to claim 8 wherein the releasable terminal regions are provided in the form of one or more beads releasably positioned under an elastic band integral with or attached to the body.

10. A device according to claim 2 wherein the orientation of the device body and its path through the water are controlled by the use of one or more edges or lips integral with or extending from the body, the orientation, angle and dimensions of which determine the path of the body as it is pulled through the water.

11. A device according to claim 2 wherein the device body is itself angled at its leading end, so as to cause the device to either skim the water surface or to catch, and thereby periodically dive into, the water surface.

12. A device according to claim 11 wherein the device body can be used in either a skimming or diving mode, by positioning a weight that will cause the device body to float in a desired orientation.

13. A device according to claim 12 wherein the weight is either temporarily or permanently attached to or embedded within the device body.

14. A kit comprising one or more components adapted to retrofit a conventional retrieving dummy in order to provide a retrieving device of claim 1.

15. A method of training dogs, comprising the steps of providing a device according to claim 1, releasably attaching the device to a casting line, casting the device over a body of water, retrieving the device by pulling the attached line, and releasing the device from the line in a desired manner.

16. A method according to claim 15 wherein the desired manner comprises a sharp tug on the casting line itself.

17. A method according to claim 15 wherein the desired path is selected from the group consisting of skimming along the top of the water, diving, or bobbing periodically, the casting mechanism comprises a portion that is attached to the body portion with sufficient strength to permit the casting line to remain attached to the device when cast, thrown, or launched and further comprising a portion adapted to be releasably attached to the device body, so as to permit the device body to be pulled through the water, and later disconnected from the casting line.

18. A method according to claim 17 wherein the releasable attachment portion comprises a metal ring, adapted to be positioned over a hook embedded in the body portion and to fall off the hook once the device body floats in the water.

19. A method according to claim 18 wherein the metal ring is attached to both the casting line itself, and at a substantially opposite point, to a terminal release rope portion that itself terminates distally with one or more enlarged terminal regions.

20. A method according to claim 19 wherein the releasable terminal regions are adapted to be positioned upon the device body and releasable terminal regions are provided in the form of one or more beads positioned under an elastic band integral with or attached to the body.
